(19) United States
(12) Patent Application Publication
(10) Pub. No.: US 2006/0219831 A1
(43) Pub. Date: Oct. 5, 2006

(54) COMPACTION AUGER FOR SHREDDER

(75) Inventor: David K Yamamoto, Paris (CA)

Correspondence Address: DARYL W SCHNURR;MILLER THOMSON LLP, PO BOX 578, SUITE 700, 22 FREDERICK STREET, KITCHENER, ON, N2G 4A2, CA

(73) Assignee: SHRED-TECH CORPORATION, CAMBRIDGE (CA)

(21) Appl. No.: 11/278,111

(22) Filed: Mar. 30, 2006

Related U.S. Application Data
(60) Provisional application No. 60/667,121, filed on Apr. 1, 2005.

(51) Int. Cl. B02C 19/22

(52) U.S. Cl. 241/260.1

(57) ABSTRACT

An auger is mounted in a trough beneath a shredder. The auger has a double flight that progressively reduces in pitch and outside diameter from a drive end to a free end. A free end of the trough has a tube concentrically aligned with a shaft of the auger. The auger forces shredded material through the tube to compact the material into logs. An auger and shredder in combination is described as well as a method of removing and compacting shredded material using an auger.

### Priority is claimed based upon U.S. Provisional Application Ser. No. 60/667,121 filed on Apr. 1, 2005.

### BACKGROUND OF THE INVENTION

1. Field of Invention

This invention relates to a compaction auger located within a trough beneath a mobile shredder and more particularly to an auger that has a reduced pitch at a free end to compact shredded material moving through the trough and increase the density of discharged material. This invention further relates to a compaction auger and mobile shredder in combination.

2. Description of the Prior Art

Shredders and mobile shredders are known and it is known to have troughs located beneath the shredder to receive shredded materials. The trough contains a rotatable auger to move the shredded material from the tough to an enclosed storage area immediately outside of said trough. In a mobile shredder, the shredder, trough and auger are mounted in a truck box with separate shredding and payload storage compartments. There is usually a hopper located above the shredder and material to be shredded is dumped into the hopper, falls onto the shredder and passes through the shredder into the trough. Since the truck box has a finite volume and maximum weight capacity, it is important that the shredded material be compacted to such an extent that the truck box can be filled with compacted shredded material up to the maximum weight capacity of the truck before the truck box becomes “full” or at least at the same time that the truck box becomes “full” on a volume basis.

Previous mobile shredding systems cannot sufficiently compact the shredded material and cannot fill with a sufficient weight of shredded material. The shredded material thus has a greater volume than would otherwise be necessary and compaction of the shredded material before it reaches the storage area can enable in a smaller truck chassis to be used, which will further result in significant cost savings and payload weight gain.

### SUMMARY OF THE INVENTION

It is an object of the present invention to provide a compaction auger for use with a shredder whereby the shredded material is compacted to such an extent that the maximum weight capacity of the truck box and truck in which the auger is located can be attained and size of the payload storage compartment minimized,

An auger is used with a mobile shredder mounted in a truck box. The auger comprises a shaft with double flights thereon, the auger being rotatably mounted at least partially within a trough located beneath the shredder. The trough receives shredded material from the shredder. The auger has a drive end and a free end, with power means for the auger being located at or near the drive end. The auger is rotatable in a direction to move shredded material from the trough to the truck box. The flights have a lesser pitch at the free end than at the drive end to compact the shredded material before the shredded material leaves the trough.

An auger and mobile shredder in combination is used by mounting in a truck box. The combination comprises an auger with a shaft having double flights thereon. The auger is rotatably mounted at least partially within a trough located beneath the shredder. The trough is located to receive shredded material from the shredder, the auger having a drive end and a free end with power means from the auger being at or near the drive end. The auger is rotatable in a direction to move shredded material from the trough. The flights have a lesser pitch at the free end and at the drive end to compact the shredded material before the shredded material leaves the trough.

A method of removing and compacting shredded material from a trough located beneath a shredder uses an auger having a lesser pitch at a free end than at a drive end. The auger is located in the trough and the free end is located at or near an opening in the trough. The method comprises operating the auger to force shredded material from the trough through the opening, the auger being shaped to compact into shape the shredded material into logs as it moves through the trough and out the opening, the auger and the opening producing logs of shredded material having a cross-sectional shape corresponding to a cross-sectional shape of the opening.

### BRIEF DESCRIPTION OF THE DRAWINGS

FIG. 1 is a perspective view of a double flight auger;

FIG. 2 is a schematic top view of the auger of FIG. 1;

FIG. 3 is a schematic end view from a drive end;

FIG. 4 is a schematic end view from a free end;

FIG. 5 is a perspective view of a trough for an auger;

FIG. 6 is a top view of said trough;

FIG. 7 is a schematic side view of said trough;

FIG. 8 is an end view of said trough from a free end;

FIG. 9 is a perspective view of an auger in a trough having a tubular opening at a free end;

FIG. 10 is a top view of the prior art auger;

FIG. 11 is a side view of the prior art auger of FIG. 10;

FIG. 12 is a schematic side view of a compaction auger angled upward;

FIG. 13 is a top view of the compaction auger;

FIG. 14 is an end view of the compaction auger viewed from a free end;

FIG. 15 is a perspective view of a shredder with shredder body made from aluminum;

FIG. 16 is a top view of a prior art shredder;

FIG. 17 is a perspective view of the prior art shredder of FIG. 16; and

FIG. 18 is a top view of the auger and trough of FIG. 9.

### DETAILED DESCRIPTION OF A PREFERRED EMBODIMENT

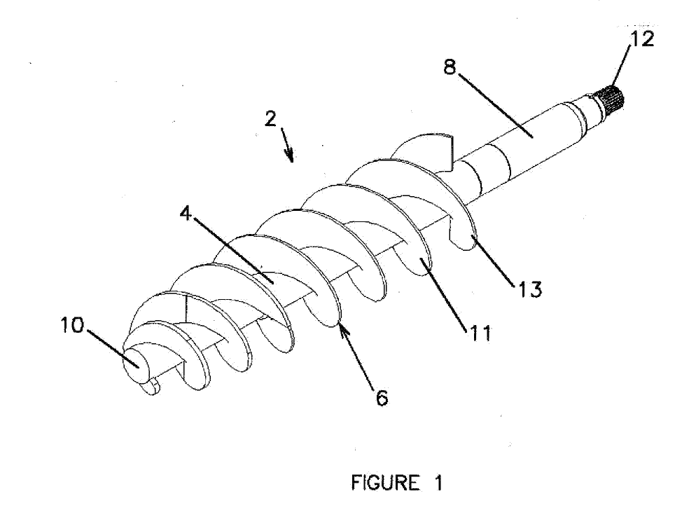

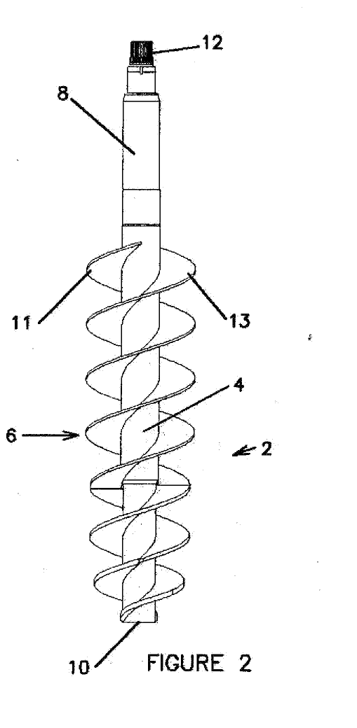

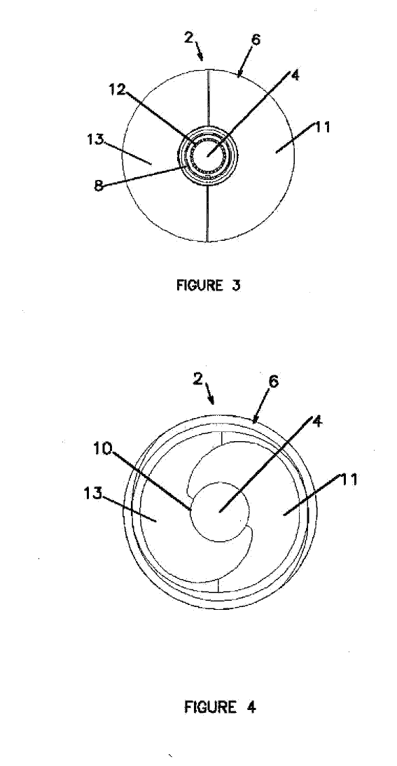

In FIGS. 1 to 4, an auger 2 has a shaft 4 with helical flight 6 thereon that extends substantially from a drive end 8 to a free end 10. The flight 6 is a double flight 11, 13. The two flights 11, 13 are one-half pitch apart from one another and are parallel to one another. The flight 6 does not extend all the way to the drive end 8 as a length of the shaft 4 is required for mounting and driving purposes. The drive end 8 of the shaft 4 has a reduced diameter with splines 12 thereon to enable the shaft to be rotatably driven. The free end of the flights are sculpted to better enable the flights 11, 13 to withstand the reaction load caused by the compacted shredded material. In FIG. 2, it can be seen that the double flights get progressively thicker toward the free end of the auger as the pressure increases with the level of compaction of the material.

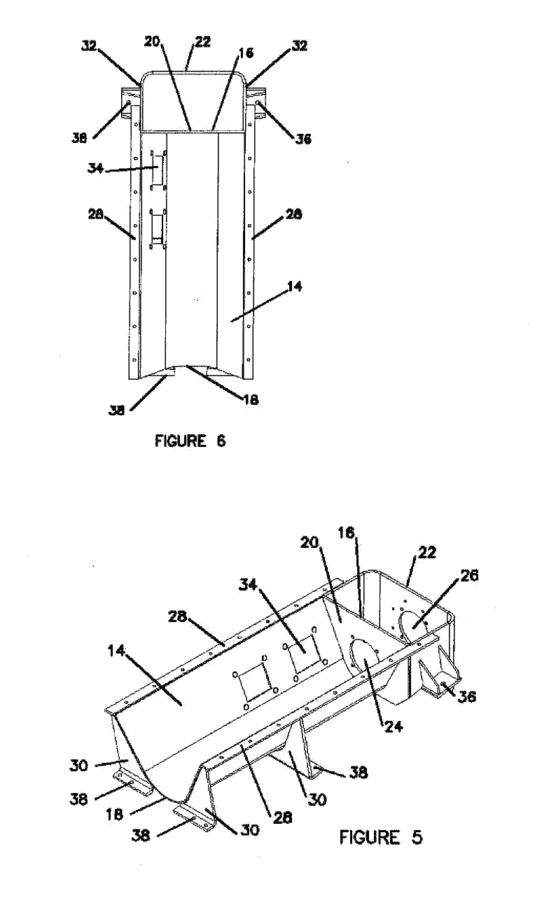

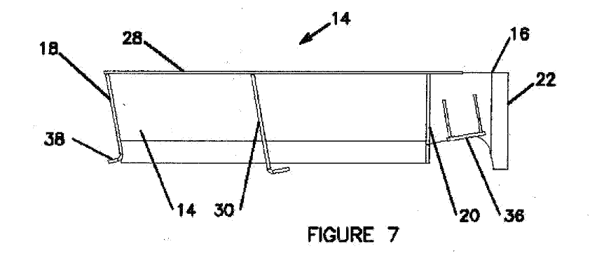

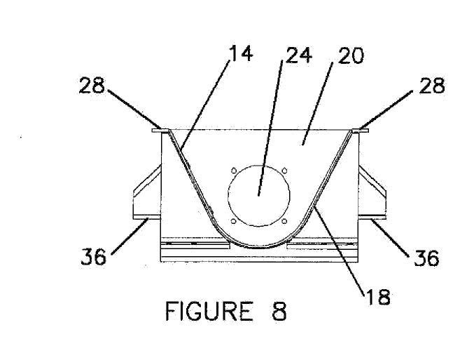

In FIGS. 5 to 8, a trough 14 has a V-shaped cross section with two ends 16, 18. At the end 16, there are located two vertical plates 20, 22 that are spaced apart from one another. The plates 20, 22 have circular openings 24, 26 respectively therein to receive the drive end 8 of the auger 2 (not shown in FIGS. 5 to 8). The V-shaped portion of the trough 14 extends from the plate 20 to the end 18. There is a flange 28 along each side of the trough 14. The trough has a plurality of holes therein to enable a shredder (not shown) to be affixed to the flange 28. The trough 14 has legs 30 at the end 18 and legs 30 at approximately a midpoint between the end 18 and the plate 20. That part of the trough 14 between the two plates 20, 22 has vertical side walls 32. There are two access openings 34 along one side of the V-shaped portion of the trough 14. The access openings are closed off by plates (not shown) and allow access to the auger into an interior of the trough to effect a repair, to service or to remove a jamb caused by shredded materials (not shown). On the outside of the vertical sidewalls 32 are connecting brackets 36. The connecting brackets are used to bolt the trough in place within the truck box (not shown). The legs 30 have flanges 38 at a bottom thereof so that the trough can be affixed to the floor (not shown) of the truck box (not shown).

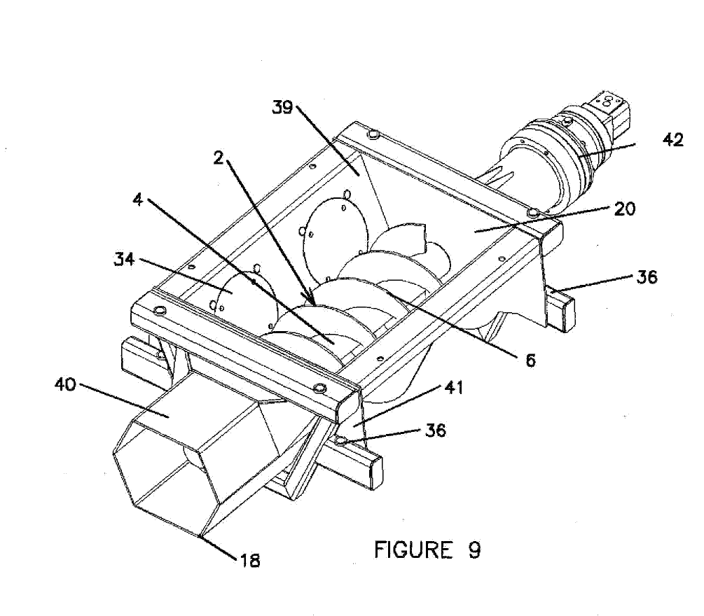

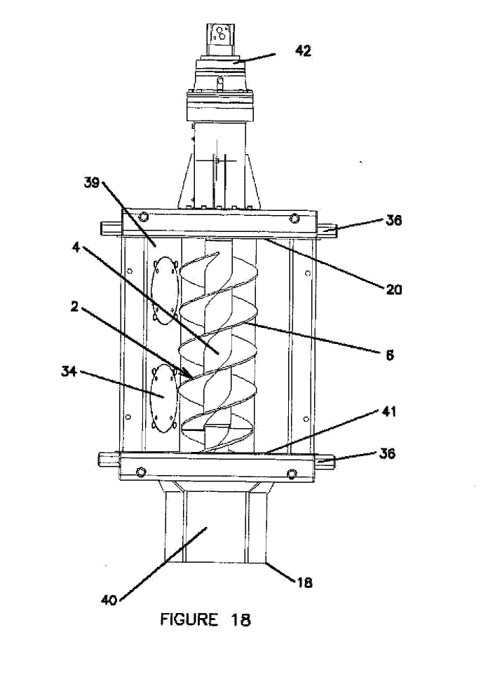

In FIG. 9, there is shown a perspective view of the auger 2 in a trough 39. The trough 39 differs from the trough 14 of FIGS. 5 to 8 in that the trough 39 is shorter than the trough 14 and has a tube 40 at the end 18 thereof. The tube 40 is mounted in a vertical plate 41 which has an opening (not shown) that is surrounded by tube structure. In order to exit the trough, the shredded material is required to pass through the opening in the tube 40 which shapes the shredded material into a the shape of the tube. The tube causes the shredded material (preferably paper) to be compacted into a hexagonal shape or continuous log (not shown) as it exits the tube 40. Preferably, the tube is concentrically mounted relative to said auger. The same reference numerals are used in FIGS. 9 and 18 as those used in FIGS. 1 to 8 to describe those components that are essentially the same. Connecting brackets 36 are of different construction in that they are tube structure rather than gusseted plates. Also, the drive end 8 is enclosed in a tube that is affixed to the plate 20 to support the auger shaft 4. FIG. 18 is a top view of the auger 2 in the trough 39. The free end 10 of the auger extends into the tube 40, but the outside diameter of the auger is sufficiently small that there is about a one inch clearance between the auger and the inside of the tube. The shaft 4 has a gearmotor 42 thereon. While the tube 40 has a hexagonal shape, various other shapes will be suitable, for example, rectangular, square and elliptical. A circular shape will also work, but is not preferred because the compacted shredder material can rotate with the auger with a cylindrical tube and is much more likely to jam. The log of shredded material is formed into the cross-sectional shape of the tube and may be continuous or may be severed from time to time.

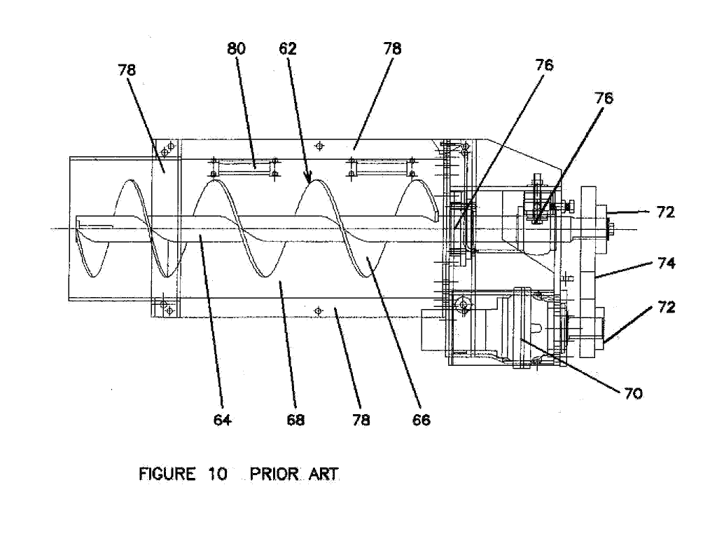

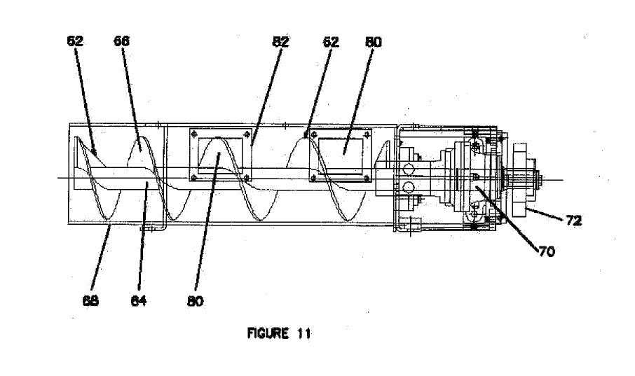

In FIGS. 10 and 11, there is shown a prior art auger 62 with a shaft 64 and flight 66. The auger 62 is rotatably mounted in a trough 68 and is powered by an hydraulic generator 70 connected by sprockets 72 and a chain 74 to rotate the auger 62. The auger is mounted in bearings 76 within the trough 68. A flange 78 around a top of the trough 68 is sized to allow the shredder (not shown in FIGS. 10 and 11) to be bolted onto the flange in such a manner that shredded material (not shown) from the shredder will fall into the trough. There are access openings 80 along a side of the trough. The access openings are closed off by cover plates 82 and allow the auger to be inspected or repaired without removing the shredder. The auger 62 is a single flight auger and the trough has a V-shaped cross section (not shown in FIGS. 10 and 11). There is no tube at the outlet.

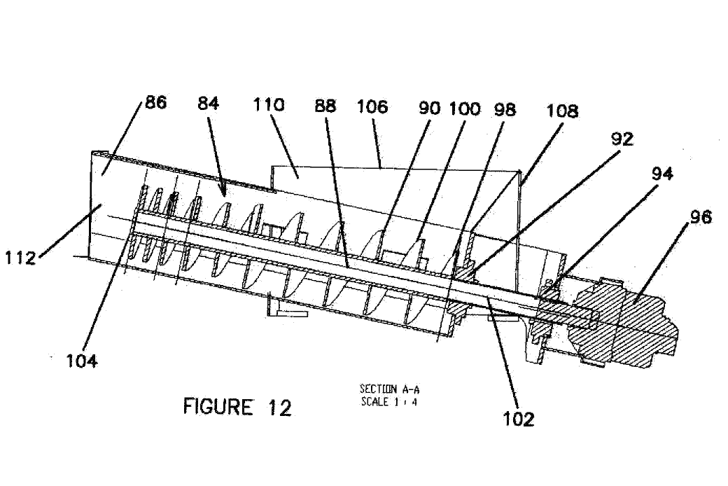

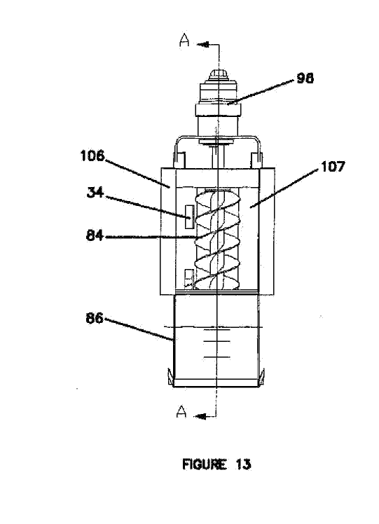

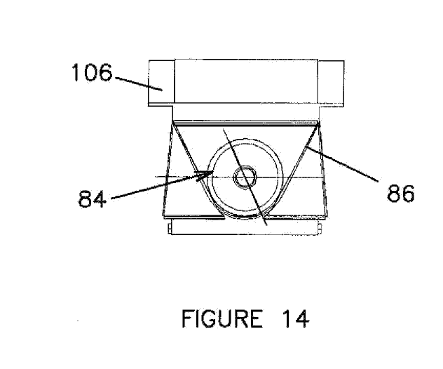

In FIG. 12, there is shown a schematic side view, partially in section, of an auger 84 in an inclined trough 86. The auger 84 has a shaft 88 with a double flight 90 thereon. The shaft 88 extends through two bearings 92, 94 directly into an hydraulic gearmotor 96. The double flight auger 90 is comprised of two helical flights 98, 100 as also shown in FIGS. 13 and 14. The flights 98, 100 are one-half pitch apart from one another. Preferably, the flights 98, 100 are parallel to one another. The pitch and outside diameter of the double flight and therefore the auger decreases from a drive end 102 to a free end 104. The trough has a flange 106 on three sides of a rectangular opening in a top 108 to allow a shredder (not shown in FIGS. 10 to 14) to be affixed to the trough. It can be seen that the trough has a V-shaped cross section and the shredder is attached at an angle relative to the auger creating additional space 110 within the trough 86 over the prior art version shown in FIGS. 10 and 11. The shredder (not shown) is horizontal and the auger is angled upward to direct output upward and rearward. The auger 84 is rotated by the gearmotor 96 in an appropriate direction to move the shredded material (not shown) to and trough an exit 112. The decreasing pitch and outside diameter of the auger, causes the shredded material to be compacted before the shredded material exits the trough. The auger 84 is said to be a compaction auger. The tube 40 can be used with the auger 84 but is not shown thereon.

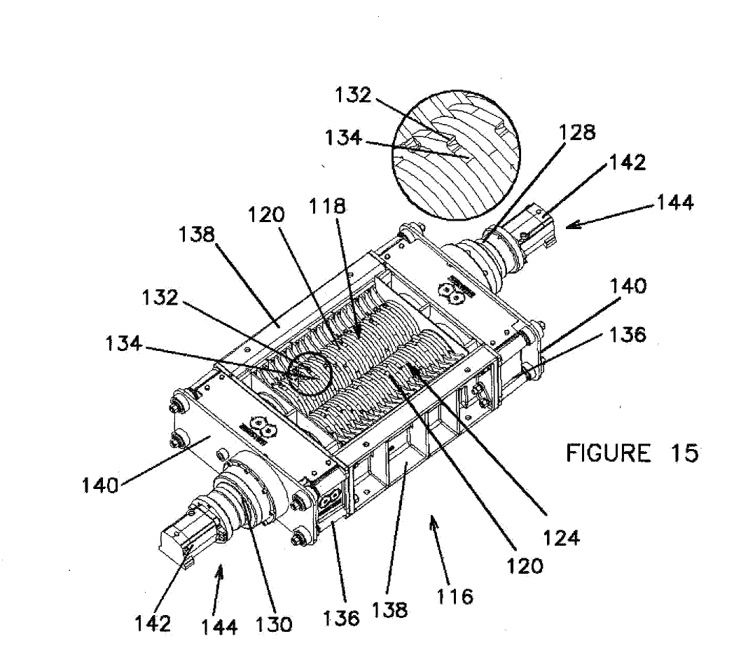

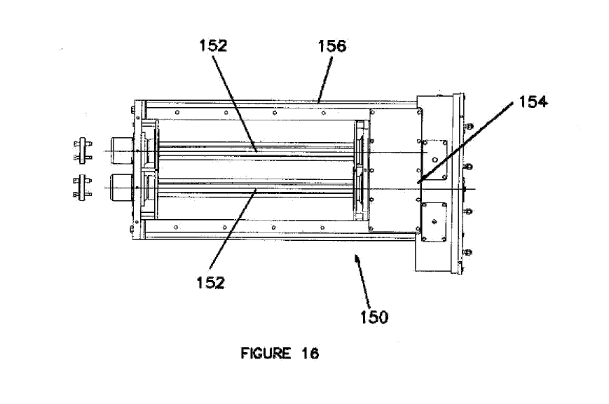

In FIG. 15, there is shown a shredder 116 having a first set 118 of knives 120 extending along a first longitudinal axis (not shown). A second set 124 of knives 120 extends along a second longitudinal axis (not shown). The first set 118 of knives 120 is rotatably mounted on a first shaft 128 and the second set 124 of knives 120 is rotatably mounted on a second shaft 130, the shafts 128, 130 being rotatable about the first and second longitudinal axes respectively. The knives 120 are in a spaced relationship along the two axes and are generally circular plates with cutting means 132 on a periphery 134 of each plate. The first and second longitudinal axes are located to enable the knives 120 of the first set 118 to partially fit between the knives 120 of the second set 124. The shredder 116 has two ends 136 and two sides 138 that together form a shredder body. The two ends 136 are preferably made of aluninum and rotatably support each of the sets 118, 124. The shafts 128, 130 extend through each of the ends 136 and are each mounted in bearings at each end (bearings not shown at each end). The first and second sets 118, 124 are each driven by independent, direct drive means 142 preferably hydraulic gearmotors). Torque arms anchor the drive to the ends 136. The drive means is connected to the drive end 144 of each of the shafts 128, 130 and are conventional. The two sides 138 and ends 136 of the shredder body are made from aluminum to reduce the weight of the shredder without sacrificing the performance. The aluminum sides preferably have a lattice shape and, still more preferably, have a ladder shape.

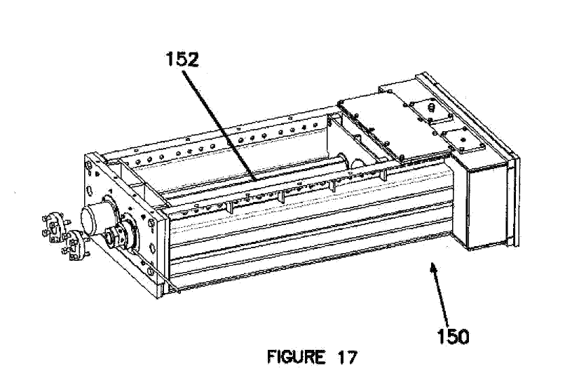

In FIGS. 16 and 17, there is shown a top view and a perspective view respectively of a prior art shredder 150 that has drive means (not shown) at one end to drive both shafts 152. A gear arrangement enclosed in gearbox 154 is used to connect the two shafts. The shredder 150 is much more complex than the direct drive shredder 116 and has many more components. The shredder 150 has a shredder body 156. Also, since both shafts are driven by the same drive means, the shafts are usually made to rotate at a set differential speed and if the direction of rotation of one of the shafts is reversed, the direction of rotation of the other shaft is also reversed. For example, one shaft can be designed to rotate 20 percent faster than the other shaft. Preferably, the drive means for the shredder is an hydraulic motor or, where the shafts are independently driven, two hydraulic gearmotors.

The auger, shredder and trough provide a unique combination whereby shredded material is not only removed from the trough by the auger, but is also compacted so that a truck body of a given size will hold significantly more material than a truck body of the same size would hold where the shredded material is not compacted or is not significantly compacted. In order to exit the trough, the shredded material is required to pass through the tubular opening which shapes the shredded material into a compacted log.

The shredder is not shown in the drawings as being affixed to the trough as the arrangement of a mobile shredder located above a trough is conventional. The drive means for the auger is also conventional. Preferably, the drive means is a direct drive means and is an hydraulic gearmotor powered by the truck in which the truck box is located. The auger of the present invention can be used with any shredder than can be affixed to the top of the trough and process shredded material of a size and type that can be compacted by the auger. Since the auger is much lighter than previous augers, that leaves greater capacity for the storage compartment of the truck box. The auger is able to compact the shredded material to a greater extent than previous augers and a greater weight of material can be stored within a given volume. Preferably, the truck box is divided by a partition between a shredded section and a storage section.

I claim:

1. An auger for use with a mobile shredder mounted in a truck box, said auger comprising a shaft with double flights thereon, said auger being rotatably mounted at least partially within a trough located beneath said shredder, said trough being located to receive shredded material from said shredder, said auger having a drive end and a free end, with power means from said auger being located at or near said drive end, said auger being rotatable in a direction to move shredded material from said trough to said truck box, said flights having a lesser pitch at said free end than at said drive end to compact said shredded material before said shredded material leaves said trough.

2. An auger as claimed in claim 1 wherein said flights are helical.

3. An auger as claimed in claim 2 wherein the pitch of said flights progressively reduces from said drive end to said free end.

4. An auger as claimed in claim 1 wherein said flights are located between said drive end and said free end and adjacent portions of said flight at said free end are closer together than adjacent portions of said flight at said drive end.

5. An auger as claimed in claim 1 wherein said truck box is divided into a shredding compartment and a payload storage compartment.

6. An auger as claimed in claim 1 wherein said shaft is hollow.

7. An auger as claimed in claim 2 wherein there are power means directly connected to said shaft.

8. Ah auger as claimed in claim 2 wherein an outside diameter of said auger progressively decreases from said shredder end to said free end.

9. An auger as claimed in claim 1 wherein the flights are sculpted at said free end.

10. An auger as claimed in claim 1 wherein the trough has transition plates therein to compact said material between the free end of said auger and an opening of said trough through which said material passes.

11. An auger as claimed in claim 1 wherein there is a shredder affixed to a top of said trough.

12. An auger as claimed in claim 1 wherein there is a plate and tube at a free end of said trough, said tube being located so that shredded material must exit from said auger through said tube.

13. An auger as claimed in claim 12 wherein said tube has a hexagonal cross section.

14. An auger as claimed in claim 12 wherein said tube has a cross-section selected from the group of rectangular, square, elliptical and circular.

15. An auger as claimed in claim 1 wherein said trough is designed to support said auger at an upward angle from said drive end to said free end.

16. An auger as claimed in claim I wherein a thickness of said double flights increases from said drive end to said free end.

17. An auger and mobile shredder in combination for use by mounting in a truck box, said combination comprising an auger with a shaft having double flights thereon, said auger being rotatably mounted at least partially within a trough located beneath said shredder, said trough being located to receive shredded material from said shredder, said auger having a drive end and a free end, with power means from said auger being at or near said drive end, said auger being rotatable in a direction to move shredded material from said trough, said flights having a lesser pitch at said free end than at said drive end to compact said shredded material before said shredded material leaves said trough.

18. An auger and shredder in combination as claimed in claim 17 wherein said shredder has a shredder body made from aluminum.

19. An auger and mobile shredder in combination for use in a truck box, said combination comprising a shredder for receiving material to be shredded and shredding that material with a trough affixed beneath the shredder to receive the shredded material that exits the shredder, said trough having an auger rotatably mounted at least partially within said trough, said auger having a drive end and a free end, with power means for said auger being located at or near said drive end, said free end extending toward a storage area of said truck box, said auger having a shaft with double flights thereon and being rotatable in the direction to move shredded material from said trough to said storage area, said flight having a lesser pitch at said free end than a pitch at or near said drive end to compact said shredded material before it leaves said trough.

20. A method of removing and compacting shredded material from a trough located beneath a shredder using an auger having a lesser pitch at a free end than at a drive end, said auger being located in said trough and said free end being located at or near an opening in said trough, said method comprising operating said auger to force shredded material from said trough through said opening, said auger being shaped to compact and to shape said shredded material into logs as said material moves through said trough and out said opening, said auger and said opening producing logs of shredded material having a cross-sectional shape corresponding to a cross-sectional shape of said opening.

21. A method as claimed in claim 20 wherein said trough has a tube at a free end surrounding said opening, said method including the step of forcing said shredded material through said tube.
